(19) United States
(12) Patent Application Publication
(10) Pub. No.: US 2020/0366330 A1
(43) Pub. Date: Nov. 19, 2020

(54) CLAMPING DEVICES FOR INTELLIGENT MOBILE TERMINAL

(71) Applicant: Zhongshan Istabilizer Photography Technology Co., Ltd., Zhongshan City (CN)

(72) Inventors: Gui Li, Zhongshan City (CN); Lifeng Yu, Zhongshan City (CN); Huaqiu Zou, Zhongshan City (CN)

(21) Appl. No.: 16/868,877

(22) Filed: May 7, 2020

(30) Foreign Application Priority Data
May 17, 2019 (CN) 201920719365.8

(51) Int. Cl. H04B 1/3877; F16B 2/12; F16M 11/22

(52) U.S. Cl. CPC H04B 1/3877; F16M 11/22; F16B 2/12

(57) ABSTRACT

A clamping device for an intelligent mobile terminal includes a first clamping member provided with a first clamping portion; and a second clamping member slidably engaged with the first clamping member and provided with a second clamping portion, a space for clamping the intelligent mobile terminal being formed between the second clamping portion and the first clamping portion, wherein an end of the first clamping member away from the second clamping member in a sliding direction is provided with a male connector, and an end of the second clamping member away from the first clamping member in the sliding direction is provided with a female connector that matches the male connector.

### TECHNICAL FIELD

The present disclosure relates to clamping devices, and in particular to a clamping device for an intelligent mobile terminal.

### BACKGROUND

Now society has entered the era of mobile data, intelligent mobile terminals such as mobile phones and tablet computers have become an essential part of people's lives, and especially now that intelligent phones have been applied to all aspects of life. However, in daily use, sometimes it is necessary to fix the intelligent mobile terminal in a certain place, so as to free up both hands to work, and then the clamping device comes into being.

Existing clamping devices generally include a first clamping member and a second clamping member slidably engaged with the first clamping member. The first clamping member is provided with a first clamping portion, the second clamping member is provided with a second clamping portion, and a space for clamping an intelligent mobile terminal is formed between the second clamping portion and the first clamping portion. The existing clamping devices are generally mounted on mobile phone brackets and have a single function.

### SUMMARY

In view of the above-mentioned current status of the prior art, the present disclosure provides a clamping device for an intelligent mobile terminal with flexible and various use modes.

In order to solve the above technical problems, a clamping device for an intelligent mobile terminal provided by the present disclosure includes a first clamping member and a second clamping member slidably engaged with the first clamping member. The first clamping member is provided with a first clamping portion, the second clamping member is provided with a second clamping portion, and a space for clamping an intelligent mobile terminal is formed between the second clamping portion and the first clamping portion. An end of the first clamping member away from the second clamping member in a sliding direction is provided with a male or female connector, and an end of the second clamping member away from the first clamping member in the sliding direction is provided with a female or male connector that matches the male or female connector.

The above-mentioned clamping device for an intelligent mobile terminal is provided with the male connector and the female connector, so that the clamping device can be used independently, or can be used in series with one or more clamping devices, which expands the use mode of the clamping device and is beneficial to meet the various needs of consumers.

In an embodiment, the male connector includes a T-shaped chuck, and the female connector includes a T-shaped slot that matches the T-shaped chuck.

In an embodiment, the T-shaped slot extends in a direction perpendicular to the sliding direction, one end of the T-shaped slot is provided with an opening capable of inserting or removing the T-shaped chuck, and the other end is provided with a limiting portion capable of limiting the T-shaped chuck.

In an embodiment, an end surface of the T-shaped chuck is provided with an elastically retractable limiting protrusion or a limiting groove, and a bottom surface of the T-shaped slot is provided with a limiting groove or an elastically retractable limiting protrusion that matches the limiting protrusion or the limiting groove.

In an embodiment, a mounting hole is provided on the end surface of the T-shaped chuck or the bottom surface of the T-shaped groove, and the limiting protrusion is mounted in the mounting hole. The first clamping member or the second clamping member is further provided with an elastic member capable of applying an elastic force to the limiting protrusion.

In an embodiment, the first clamping portion and/or the second clamping portion include(s) a mounting groove and an elastic pad mounted in the mounting groove, the mounting hole extends through to a bottom surface of the mounting groove, and the elastic member is the elastic pad.

In an embodiment, the limiting protrusion has a spherical or cylindrical shape.

The beneficial effects of the additional technical features of the present disclosure will be described in the detailed description of this specification.

### BRIEF DESCRIPTION OF THE DRAWINGS

FIG. 1 is a perspective view of a clamping device for an intelligent mobile terminal according to an embodiment of the present disclosure.

FIG. 2 is a cross-sectional view of the clamping device of FIG. 1.

FIG. 3 is a cross-sectional view of the clamping device of FIG. 2 in a use state.

### DETAILED DESCRIPTION

The present disclosure will be described in detail below with reference to the drawings and in combination with embodiments. It should be noted that, in the case of no conflict, the following embodiments and features in the embodiments can be combined with each other.

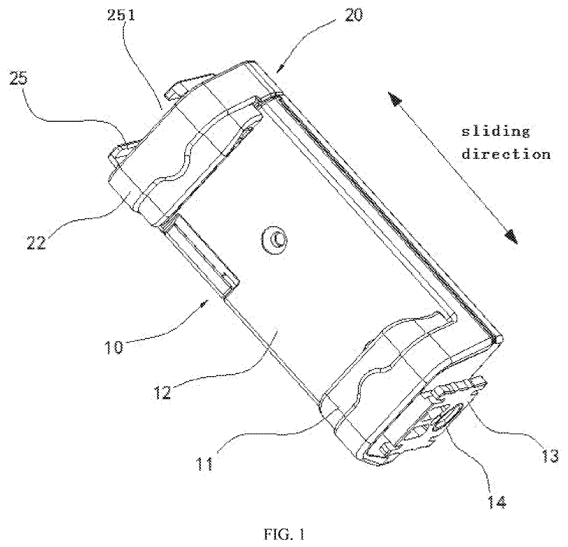

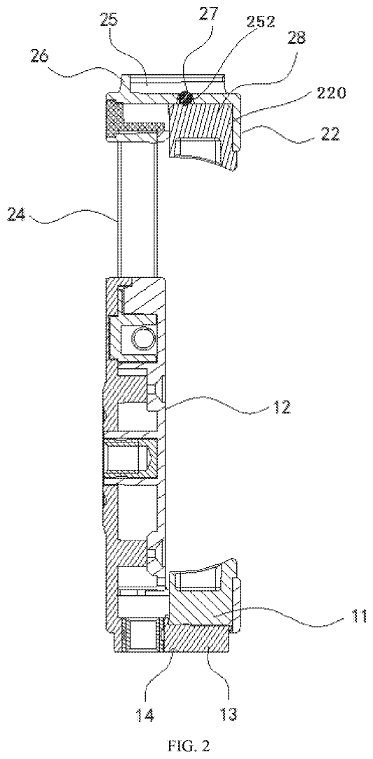

As shown in FIGS. 1 and 2, a clamping device for an intelligent mobile terminal in an embodiment of the present disclosure includes a first clamping member 10 and a second clamping member 20. The first clamping member 10 is provided with a first clamping portion 11. The second clamping member 20 is slidably engaged with the first clamping member 10, and the second clamping member 20 is provided with a second clamping portion 22. A space for clamping the intelligent mobile terminal (such as a mobile phone, a tablet computer, etc.) is formed between the first clamping portion 11 and the second clamping portion 22.

In the illustrated embodiment, the first clamping member 10 includes a first clamping portion 11 and a receiving housing 12 extending from the first clamping portion 11 in a sliding direction toward a side of the second clamping member 20. An end surface of the receiving housing 12 facing the second clamping member 20 is provided with an extension opening. The second clamping member 20 includes a second clamping portion 22 and a guiding post 24 extending from the second clamping portion 22 in the sliding direction toward a side of the first clamping member 10. The guiding post 24 is inserted into the receiving housing 12 from the extension opening, and is slidable in the sliding direction.

As shown in FIGS. 1 and 2, an end of the first clamping member 10 away from the second clamping member 20 in the sliding direction is provided with a male connector, and an end of the second clamping member 20 away from the first clamping member 10 in the sliding direction is provided with a female connector that matches the male connector. In alternative embodiments, the male connector can be provided on the second clamping member 20, and the female connector can be provided on the first clamping member 10.

In the illustrated embodiment, the male connector is a T-shaped chuck 13, and the female connector is a T-shaped slot 25 that matches the T-shaped chuck 13. The contact area between the T-shaped chuck 13 and the T-shaped slot 25 is large, thus the connection is firm. In the illustrated embodiment, the T-shaped slot 25 extends in a direction perpendicular to the sliding direction, one end of the T-shaped slot 25 is provided with an opening 251 capable of inserting or removing the T-shaped chuck 13, and the other end is provided a limiting position 26.

In the illustrated embodiment, an end surface of the T-shaped chuck 13 is provided with a limiting groove 14, and a bottom surface of the T-shaped slot 25 is provided with an elastically retractable limiting protrusion 27 that matches the limiting groove 14. When the T-shaped chuck 13 is inserted into the T-shaped slot 25, the limiting protrusion 27 is locked into the limiting groove 14 to prevent the T-shaped chuck 13 from slipping out of the T-shaped slot 25 easily. It should be understood that, in alternative embodiments, the limiting groove 14 can be provided on the bottom surface of the T-shaped slot 25, while the elastically retractable limiting protrusion 27 is provided on the end surface of the T-shaped chuck 13.

In the illustrated embodiment, a mounting hole 252 is provided on the bottom surface of the T-shaped groove 25. The limiting protrusion 27 is in a spherical or cylindrical shape. The limiting protrusion 27 is mounted in the mounting hole 252, and the second clamping member 20 is further provided with an elastic member capable of applying an elastic force to the limiting protrusion 27. In alternative embodiments, the mounting hole can be provided on an end surface of the T-shaped chuck 13.

In an embodiment, the second clamping portion 22 includes a mounting groove 220 provided on an end of the second clamping member 20 away from the first clamping member 10 and an elastic pad 28 mounted in the mounting groove 220. The mounting hole 252 extends through the second clamping member 20 to a bottom surface of the mounting groove. The elastic pad 28 is in contact with the limiting protrusion 27, and an elastic force is applied to the limiting protrusion 27 through the elastic pad 28.

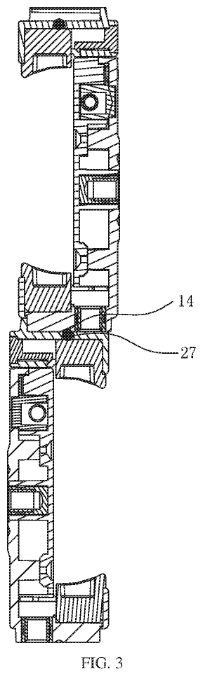

As shown in FIG. 3, when two or more intelligent mobile terminals need to be clamped at the same time, the T-shaped chuck 13 of one clamping device can be inserted into the T-shaped slot 25 of another clamping device. When the T-shaped chuck 13 is completely inserted into the T-shaped slot 25, the limiting protrusion 27 is locked into the limiting groove 14 under the action of the elastic pad 28, thus achieving a reliability connection between the two intelligent mobile terminals clamping devices.

The clamping device according to this embodiment can be used independently, or can be used in series with one or more clamping devices, which expands the use mode of the clamping device for an intelligent mobile terminal and is beneficial to meet the various needs of consumers.

The above embodiments merely represent several embodiments of the present disclosure, and the description thereof is more specific and detailed, but they should not be construed as limiting the scope of the disclosure. It should be noted that for those skilled in the art, several variations and improvements may be made without departing from the concept of the present disclosure. And these are all within the protection scope of the present disclosure.

What is claimed is:

1. A clamping device for an intelligent mobile terminal, the clamping device comprising:
a first clamping member provided with a first clamping portion; and
a second clamping member slidably engaged with the first clamping member and provided with a second clamping portion, a space for clamping the intelligent mobile terminal being formed between the second clamping portion and the first clamping portion, wherein an end of the first clamping member away from the second clamping member in a sliding direction is provided with a male connector, and an end of the second clamping member away from the first clamping member in the sliding direction is provided with a female connector that matches the male connector.

2. The clamping device according to claim 1, wherein the male connector includes a T-shaped chuck, and the female connector includes a T-shaped slot that matches the T-shaped chuck.

3. The clamping device according to claim 2, wherein the T-shaped slot extends in a direction perpendicular to the sliding direction, one end of the T-shaped slot is provided with an opening capable of inserting or removing the T-shaped chuck, and the other end is provided with a limiting portion capable of limiting the T-shaped chuck.

4. The clamping device according to claim 2, wherein an end surface of the T-shaped chuck is provided with an elastically retractable limiting protrusion, and a bottom surface of the T-shaped slot is provided with a limiting groove that matches the limiting protrusion.

5. The clamping device according to claim 4, wherein a mounting hole is provided on the end surface of the T-shaped chuck or the bottom surface of the T-shaped groove, the limiting protrusion is mounted in the mounting hole, the first clamping member or the second clamping member is further provided with an elastic member capable of applying an elastic force to the limiting protrusion.

6. The clamping device according to claim 5, wherein the first clamping portion or the second clamping portion includes a mounting groove and an elastic pad mounted in the mounting groove, the mounting hole extends through the second clamping member to a bottom surface of the mounting groove, and the elastic member is the elastic pad.

7. The clamping device according to claim 5, wherein the limiting protrusion has a spherical shape.
